(19) United States
(12) Patent Application Publication
(10) Pub. No.: US 2016/0014669 A1
(43) Pub. Date: Jan. 14, 2016

(54) DEFAULT DATA PATH FOR NAN AIDED CONNECTIVITY

(71) Applicant: QUALCOMM Incorporated, San Diego, CA (US)

(72) Inventors: Abhishek Pramod Patil, San Diego, CA (US); Menucher Behram Menuchehry, San Diego, CA (US); George Cherian, San Diego, CA (US); Santosh Paul Abraham, San Diego, CA (US)

(21) Appl. No.: 14/518,168

(22) Filed: Oct. 20, 2014

Related U.S. Application Data
(60) Provisional application No. 62/023,170, filed on Jul. 10, 2014.

(51) Int. Cl. H04W 40/24; H04W 56/00; H04W 72/04; H04L 12/741

(52) U.S. Cl. CPC H04W 40/246; H04L 45/74; H04W 56/002; H04W 72/0406

(57) ABSTRACT

Methods, devices, and apparatuses for wireless communications in stations of a Neighbor Awareness network (NAN) cluster are disclosed that may utilize a default data path of a wireless network. A first station may receive a message from a second station, the message may identify whether the second station wants to utilize a default data path or a customized data path for subsequent data transmission. The first station may determine to utilize the default data path for data transmissions based at least in part on requirements of the first station and an identifier included in the message.

### CROSS REFERENCES

The present application for patent claims priority to U.S. Provisional Patent Application No. 62/023,170 by Patil et al., entitled “Default Data Path for NAN Aided Connectivity,” filed Jul. 10, 2014, assigned to the assignee hereof, and expressly incorporated by reference herein.

### BACKGROUND

The following relates generally to wireless communication, and more specifically to utilizing a default data path of a wireless network in a neighbor awareness network (NAN). Wireless communications systems are widely deployed to provide various types of communication content such as voice, video, packet data, messaging, broadcast, and so on. These systems may be multiple-access systems capable of supporting communication with multiple users by sharing the available system resources (e.g., time, frequency, and power).

A wireless network, for example a wireless local area network (WLAN), may include an access point (AP) that may communicate with one or more station (STAs) or mobile devices. The AP may be coupled to a network, such as the Internet, and may enable a mobile device to communicate via the network (and/or communicate with other devices coupled to the access point). A wireless device may communicate with a network device bi-directionally. For example, in a WLAN, a STA may communicate with an associated AP via downlink (DL) and uplink (UL). The DL (or forward link) may refer to the communication link from the AP to the station, and the UL (or reverse link) may refer to the communication link from the station to the AP.

Therefore, a wireless multiple-access communications system may include a number of access points, each simultaneously supporting communication for multiple mobile devices. However, deploying large number of base stations or access points with wired infrastructure may not be cost effective. An alternative to the traditional method of wireless communication includes a wireless mesh network where mobile devices (and other wireless communication devices) may form networks without base stations, access points or equipment other than the mobile devices themselves.

Wireless mesh networks are dynamically self-organized and self-configured with stations in the network automatically establishing an ad-hoc network with other stations such that the network connectivity is maintained. In a mesh network topology, each STA relays data for the network and all stations cooperate in the distribution of data within the network. In some examples, a neighbor awareness network (NAN) provides a one-hop service discovery between STAs on the network. However, conventional NAN deployments do not provide any mechanism for post-discovery connectivity. Specifically, NAN systems fail to provide a mechanism to communicate between STAs beyond a one-hop connectivity.

### SUMMARY

Described embodiments are directed to methods, devices, and apparatuses for wireless communications by STAs in a NAN cluster that may utilize a default data path for exchanging data. In some examples of the present disclosure, an on-demand default data path for establishing communication between multiple NAN STAs may be created based on beacon messages of a master node. In accordance with the present disclosure, the default data path utilizing a mesh network topology may allow STAs to establish connectivity beyond the traditional one-hop configuration. Thus, the present disclosure provides reliable means for a first STA on the network to transmit data to a second STA on the network without specifying a customized path for each data transmission.

In a first illustrated example, a method of wireless communication is disclosed. The method may comprise receiving at a first station a message from a second station and determining whether to utilize the default data path for data transmissions based at least in part on the received message. Based on the determination, the method may include transmitting data over the default data path.

In a second illustrated example, an apparatus for wireless communication is disclosed. The apparatus may include a processor and a memory in electronic communication with the processor. The apparatus may further include instructions stored in the memory, wherein the instructions are executable by the processor to receive at a first station a message from a second station and determine whether to utilize the default data path for data transmissions based at least in part on the received message. The apparatus may further include instructs to transmit data over the default data path based on the determining.

In a third illustrated example, a non-transitory computer-readable medium storing code for wireless communication is disclosed. The code may comprise instructions executable by a processor to receive at a first a message from a second station and determine whether to utilize the default data path for data transmissions based at least in part on the received messages. The code may further include instructions to transmit data over the default data path based on the determining.

In a fourth illustrated example, another apparatus for wireless communication is disclosed. The apparatus may comprise means for receiving at a first station a message from a second station and means for determining whether to utilize the default data path for data transmissions based at least in part on the received message. The apparatus may further include means for transmitting data over the default data path based on the determining.

In some examples of the method, apparatus, and/or non-transitory computer readable medium described above, determining whether to utilize the default data path may comprise determining whether message includes a path identifier and selecting the default data path upon determining that the message fails to include the path identifier. In some examples, the message may include a path identifier, the path identifier indicating whether the default data path or a customized data path should be utilized for data transmission.

In other examples, determining whether to utilize the default data path may comprise determining that an application for the first station requires enhanced encryption feature or a custom data path, the determination based on requirements specified by the first station. Additionally or alternatively, the method, apparatus and/or non-transitory computer readable medium may comprise receiving an advertisement message from an anchor master device, wherein the advertisement message included in a beacon comprises attributes associated with the default data path. In some examples, the attributes may include at least one of a selected channel and transmission schedule information of the default data path.

In accordance with the present disclosure, the advertisement message may be received during a periodic Neighbor Awareness Network (NAN) discovery window. The advertisement message may further identify a data session window for the first station to transmit traffic over the default data path. In some examples, transmitting data over the default data path may include transmitting during the identified data session window. In some examples, the method may include transmitting a traffic announcement during a paging window. The paging window duration may be selected based in part on a number of devices participating on the default data path. In accordance with the present disclosure, the paging window occurs during a synchronized time interval and all stations on the default data path are in an active state during the paging window interval.

In some examples of the present disclosure, the traffic announcement may be transmitted using Traffic Indication Map (TIM) message. The traffic announcement message may be transmitted using Service Response Filter (SRF) field in NAN service discovery message. In some examples, synchronizing all stations on a NAN may be based in part on information received from beacons transmitted by the second station.

In yet further example, the method, apparatus, and/or non-transitory computer readable medium describe above may include determining that the transmission of data over the default data path is completed, and terminating the transmission over the default data path. Additionally or alternatively, the method may determine that a service is unavailable, and cease to transmit over the default data path based on the determining.

Further scope of the applicability of the described methods and apparatuses will become apparent from the following detailed description, claims, and drawings. The detailed description and specific examples are given by way of illustration only, since various changes and modifications within the scope of the description will become apparent to those skilled in the art.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 shows a block diagram of a neighbor aware network in accordance with various embodiments;

FIG. 2 shows a diagram that illustrates an example of a NAN cluster according to various embodiments;

FIG. 3 is a message flow diagram illustrating a flow of communications between a requesting device and member devices, in accordance with various embodiments;

FIG. 4 shows a timing diagram illustrating timing aspects, in accordance with various embodiments;

FIG. 5A shows a block diagram of an exemplary wireless communications device, in accordance with various embodiments;

FIG. 5B shows a block diagram illustrating a further embodiment of the wireless communication device;

FIG. 6 shows a block diagram of one configuration of a wireless communication device, in accordance with various embodiments;

FIG. 7 is a flowchart illustrating an embodiment of a method for communications via a network, in accordance with various embodiments;

FIG. 8 is a flowchart illustrating an embodiment of a method for communications via a network, in accordance with various embodiments;

FIG. 9 is a flowchart illustrating an embodiment of a method for communications via a network, in accordance with various embodiments; and

FIG. 10 is a flowchart illustrating an example of a method for communications via a network, in accordance with various embodiments.

### DETAILED DESCRIPTION

The described features generally relate to improved systems, methods, and/or apparatuses for reducing contention in a mesh network, such as a social Wi-Fi mesh. In accordance with the present disclosure, a social Wi-Fi mesh network may be implemented to support multi-hop communication for a Neighbor Awareness Network (NAN). Social Wi-Fi mesh network or NAN network may refer to coordinated distribution of data within a group of STAs without utilization of a central AP. Accordingly, STAs on the Social Wi-Fi mesh network may share services with one another by establishing an ad-hoc network and routing data from one STA to the next within a certain radius. In some examples, a mesh network may be a full mesh network in which each member station has a connection with every other station on the network. Also, a mesh network may be a partial mesh network in which some member stations may be connected in a full mesh scheme, but other member stations are only connected to one or more of the stations, but not all of the member stations of the network. Further, a social Wi-Fi mesh network may extend the capabilities of a social Wi-Fi framework to enable participating stations to establish mesh connectivity for content delivery.

Mesh networks may be used for static topologies and ad-hoc or neighbor awareness networks. The terms “Social Wi-Fi,” (SWF) and “NAN” may be used interchangeably herein. A network may comprise a plurality of mesh devices, each of which is capable of relaying data within the network on behalf of other mesh devices in a SWF environment. The data transmitted or routed between the mesh devices may similarly create a data path (“DP”) wherein the “path” describes the data flow from one mesh device to another. Accordingly, a Social Wi-Fi Mesh (SWF-mesh) may also be referred to as a NAN data path (NAN DP), comprising data transferred from a service provider to a service consumer, as described below. As described herein, a mesh may be generally referred to as a DP, although the two terms may be interchanged.

A NAN DP may include more than one “hop.” A “hop” as used herein depends on the number of mesh devices between the device providing the service (provider device) and the device consuming the service or “subscribing” (subscriber device) to the service in the DP. For example, a service that is relayed by one mesh device may be referred to as two hops: provider STA (hop one) to proxy STA, (hop two) to seeker STA. While NAN may refer to a subset or network of devices capable of one-hop service discovery, a DP may be capable of service discovery and subscription over multiple hops (multi-hop).

In certain embodiments, a “mesh group” or a “DP group” may be used. A DP group may generally refer to a subset of a NAN cluster that shares a paging window (PW). The PW for the DP group may have common security credentials for each of the mesh devices, which may serve to restrict membership within the DP. Accordingly, a restricted DP may require out-of-band credentialing.

In some examples, a NAN cluster may utilize a default data path of a mesh wireless network. In accordance with the present disclosure, a mesh network overlay may provide post-discovery connectivity between multiple devices in the NAN. A mesh networks may be formed between a device and one or more other devices to provide one or more services to the device from the other device(s). In order to establish a mesh network for such communications, the device (joining device) may discover or otherwise become aware of the other device(s). These other devices may be referred to as member device(s). One or more of the other member device(s) may provide a desired service, e.g., access to the Internet or music streaming. The other member device(s) may be referred to as a provider member device(s) or station(s).

In one example, a wireless communication device may join a mesh network by authenticating with only one of the member devices of the existing mesh network. Upon successfully completing the single authentication procedure, the wireless communication device may receive a group key common to the devices of the mesh network and use the common group key to discover the topology of the existing mesh network by sending a route request message to the other devices and receiving route reply messages from one or more of the other devices. Based on the received route reply messages, the joining device may determine a topology of the mesh network and, accordingly, determine a route or path to a provider device of the mesh network providing a desired service. In some examples, a NAN device may broadcast a beacon or periodically broadcast an advisement to all member stations on the network. The advertisements may comprise information and attributes related to a default data path and/or route associated with the mesh network. In some examples, the default data path information may be related to the topology of the mesh network operating over the NAN. Additionally or alternatively, the advertisement information may include selected channel and/or control information of the default data path.

In some examples, a first station interested in establishing communication with a second station on the neighbor aware network may transmit a message comprising an identifier (e.g., subscription request) to the second station identifying the default data path as means for subsequent data transmission. In response, the receiving device may switch to the designated default data path channel utilizing control information broadcasted by the NAN master device. In some examples, the NAN device configured to broadcast and/or beacon information to the network regarding attributes associated with the default data path may be an anchor master device.

Thus, the following description provides examples, and is not limiting of the scope, applicability, or configuration set forth in the claims. Changes may be made in the function and arrangement of elements discussed without departing from the scope of the disclosure. Various embodiments may omit, substitute, or add various procedures or components as appropriate. For instance, the methods described may be performed in an order different from that described, and various steps may be added, omitted, or combined. Also, features described with respect to certain embodiments may be combined in other embodiments.

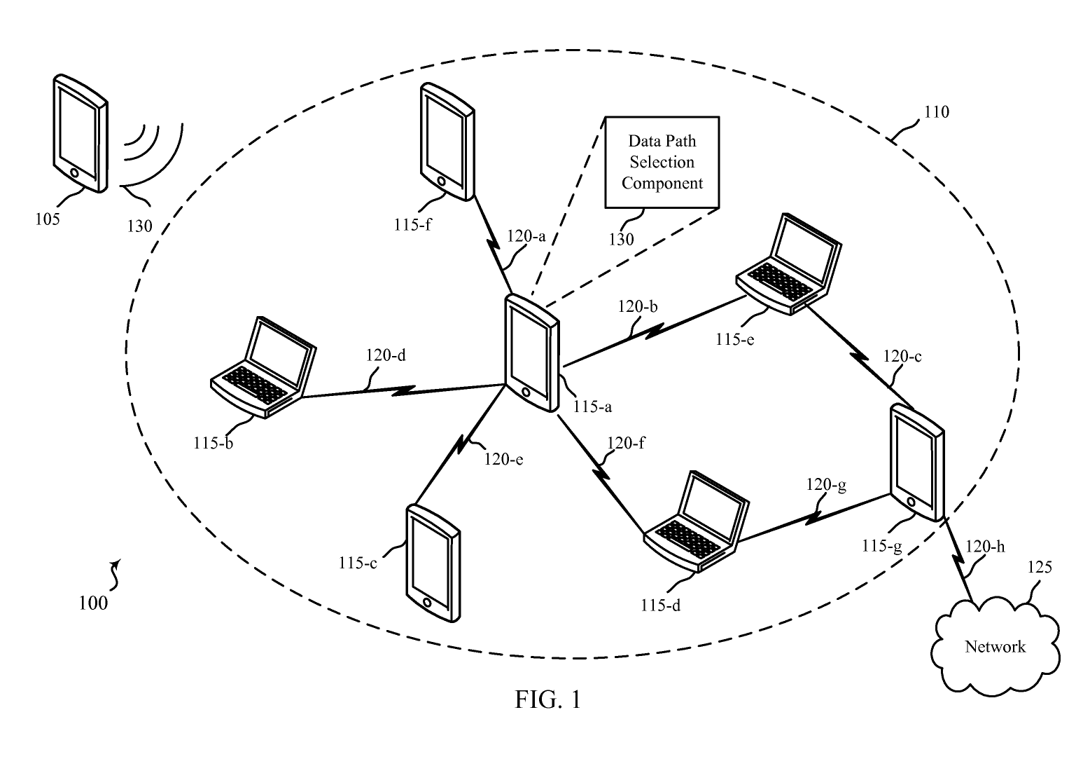

FIG. 1 illustrates a WLAN 100 (also referred to as a Wi-Fi network or a mesh network) configured in accordance with various aspects of the present disclosure. The Wi-Fi network 100 includes an established mesh network 110. The mesh network 110 may be implemented as a wired or wireless communication network of various fixed and/or mobile devices, that may be referred to as “nodes” or “stations” 115. Each of the node devices 115 may receive and communicate data throughout the mesh network, such as throughout a college campus, metropolitan area, community network, and across other geographic areas. A node device 115 may also function to route data from one node to another within the mesh network 110. In addition, each node may typically have more than one communication link to and/or from other nodes of the network, which provides for redundant communication links and a reliable communication system. For instance, node 115-a may establish communication with node 115-g via either intermediate nodes 115-d or 115-e respectively.

As shown in FIG. 1, the mesh network 110 is a partial mesh network, with connections or communication links 120 established between the nodes 115-a through 115-g such that each of the nodes may communicate with all of the other nodes of the mesh network 110, some directly and some indirectly. The mesh network 110 may be connected to an external network 125, such as the Internet, by one or more of the member devices (e.g., node 115-g in this example) establishing a connection or communication link 120 with the external network 125. Although not shown, the node 115-g may establish its connection with a base station or access point that has access to the external network 125.

The wireless mesh network 110 may include various node devices 115 implemented for wireless communication utilizing a data packet routing protocol, such as Hybrid Wireless Mesh Protocol (HWMP) for path selection. In some examples, the wireless mesh network 110 may also be implemented for data communication with other networks that are communicatively linked to the mesh network, such as with another wireless network, wired network, wide-area-network (WAN), and the like.

In the wireless mesh network 110, communication links 120 may be formed between the various nodes 115 of the network. The data packets for wireless communication in the network may be forwarded or routed from a source node (e.g., transmitting device) to an originator node (e.g., receiving device) via intermediate node(s), which are commonly referred to as “hops” in a multi-hop wireless mesh network. For instance, communication from a first node 115-a to second node 115-f via communication link 120-a may be considered “one-hop.” Similarly, communication between a first node 115-a to a third node 115-g via intermediate node 115-e and communication links 120-b and 120-c may be considered “two-hops” for the purpose of this disclosure. Communication between multiple devices, however, is not limited to either one or two hops, and may comprise any number of hops required for establishing communication between a plurality of mobile devices via the selected path.

In one example, wireless communication device 105 may be in proximity of the mesh network 110. The wireless communication device 105 may join the mesh network 110 by authenticating with only one of the member nodes 115 of the existing mesh network 110. Upon successfully completing a single authentication procedure, the wireless communication device 105 may receive a group key common to the devices of the mesh network and use the common group key to discover the topology of the existing mesh network 110 by sending a route request message to the other devices and receiving route reply messages from one or more of the other devices. Based on the received route reply messages, the wireless communication device 105 may determine a topology of the mesh network 110 and, accordingly, determine a route or path to a provider device of the mesh network providing a desired service.

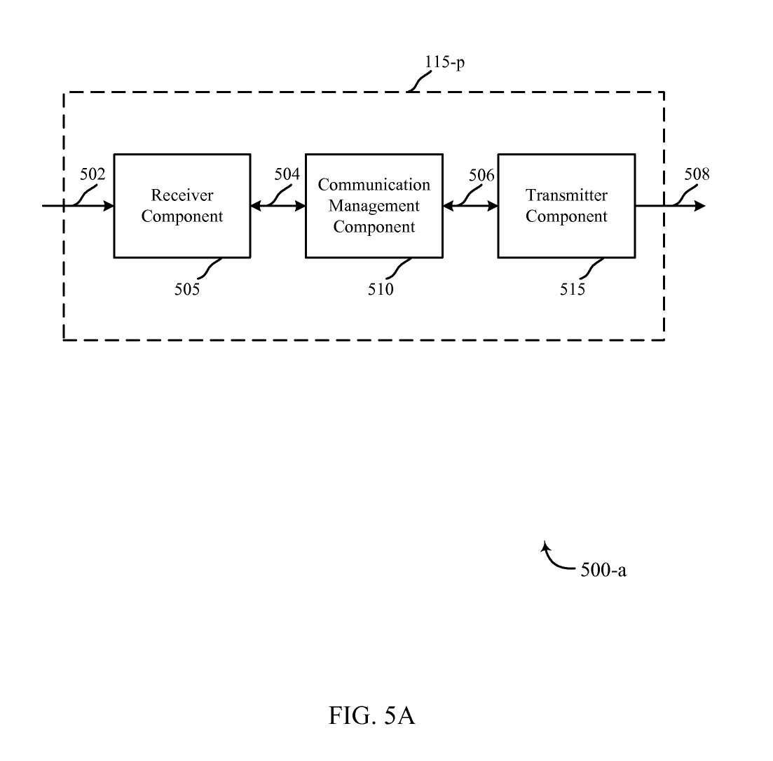

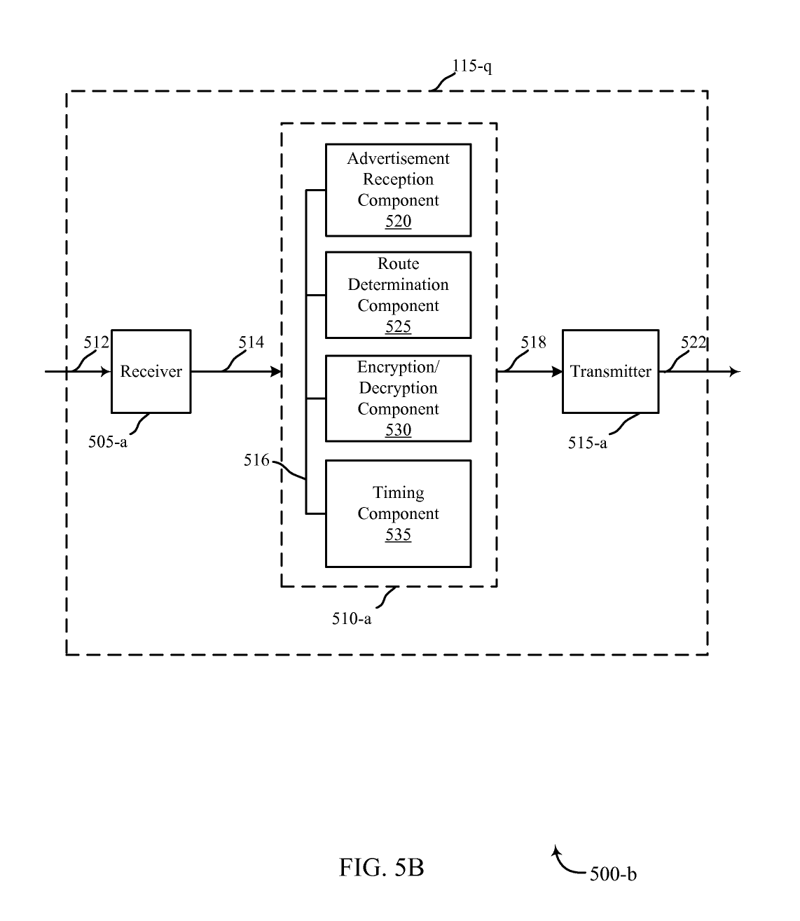

In one configuration, a STA (e.g., nodes 115-g) may request content delivery (e.g., music streaming) from source STA (e.g., 115-a) of the mesh network 110. In accordance with the present disclosure, one or more STAs 115 may include a data path selection component 130 configured to perform the functionalities of the present disclosure. In one example, the data path selection component 130 may execute the functionalities of communication management component 510 described with reference to FIG. 5. In some examples, the source STA 115-a may receive a message (e.g., subscription request) from STA 115-g. The message may include an identifier that indicates to STA 115-a whether the requesting STA 115-g intends to utilize a default data path or a customized data path for subsequent communication. In other examples, the source STA 115-a may determine to utilize a default data path in an absence of the identifier in the message indicating the request STA 115-g preference. Thus, in accordance with the present disclosure, the source STA 115-a, based on the received message and determination of application specific parameters, may utilize an established default data path between STA 115-a and STA 115-g to transmit packets. In such instance, the STA 115-a may utilize default data path based on parameters advertised by a master node (e.g., STA 115-d) regarding the established default data path. The advertised parameters (also referred to as Data Path attributes) may include attributes regarding the mesh network and/or the default data path, including identifying when the mesh transmission window starts, start time offset between consecutive transmission windows, the size of the transmission window, the size of the paging window, and the time slots associated with each of the paging window and the transmission window.

In other examples, the STA 115-a may determine to utilize a customized data path based on a predefined factors to establish connectivity between STA 115-a and STA 115-g. The determination to utilize a customized data path may be based on an identifier in the received message or a determination that the contents of the data transmission require enhanced security protocols and/or a customized data path for establishing efficient communication.

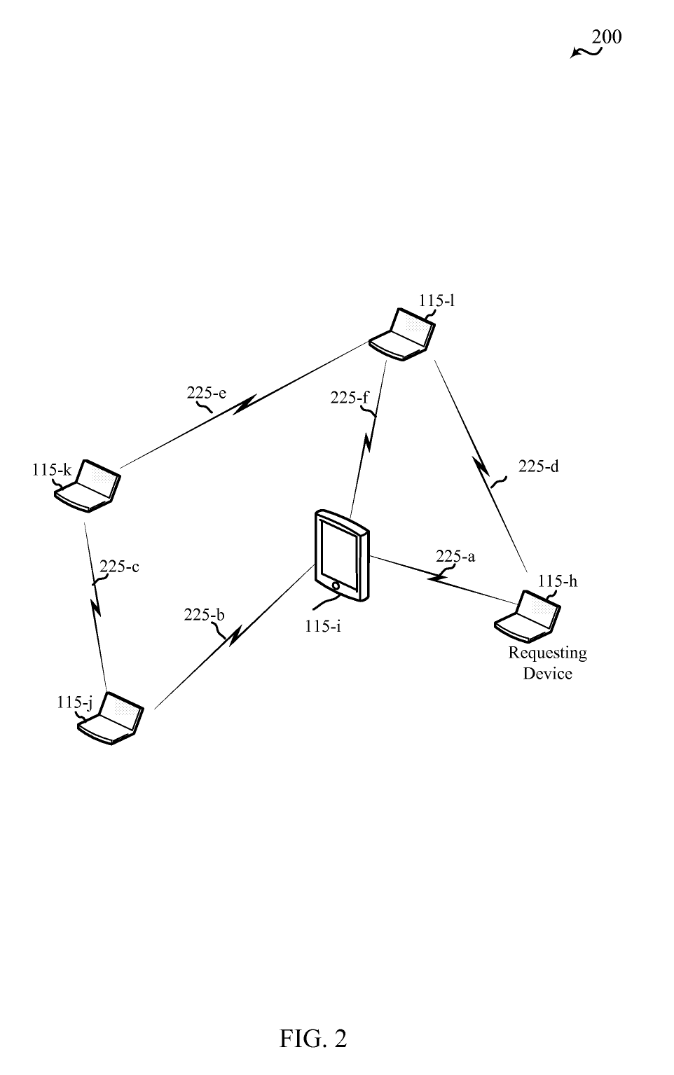

Referring to FIG. 2, a system 200, which may be referred to as a NAN cluster, is shown that illustrates multiple stations 115 configured in a NAN that communicate with each other using communication links 225. In some examples, the stations 115 may be examples of the stations 115 of FIG. 1.

In one example, NAN information required for establishing connectivity may be periodically transmitted in a NAN beacon from a master STA (e.g., 115-i). In some examples, the master STA 115-i may transmit the NAN beacon once every 512 ms using a predefined channel in the radio spectrum used by system 200. In certain examples, while the NAN system 200 may provide one hop service discovery to the requesting STA 115-h by establishing communication with a one-hop STA (e.g., 115-l), a standalone NAN architecture does not provide mechanism for the requesting STA 115-h to establish post-discovery connectivity with other member STAs 115 in the NAN cluster. To remedy this problem a mesh network may be implemented as a wired or wireless network overlay for the NAN cluster 200.

In one illustrated example, STAs 115 may also function to route data from one node to another within the mesh network. In addition, each STA 115 may typically have more than one communication link to and/or from other nodes of the network, which provides for redundant communication links and a reliable communication system. The wireless mesh network may also be implemented for data communication with other networks that are communicatively linked to the mesh network, such as with another wireless network, wired network, wide-area-network (WAN), and the like.

In the wireless mesh network overlay, communication links 225 may be formed between the various stations 115 of the network. The data packets for wireless communications in the network may be forwarded or routed from a source STA (e.g., transmitting device) to a destination STA (e.g., receiving device) via intermediate STA(s) or node(s), which are commonly referred to as “hops” in a multi-hop wireless mesh network. The number of intermediate STA(s) between the transmitting device and the receiving device may be referred to as the hop count. Thus, in one example, the requesting STA 115-h may request communication with the service device 115-k in the NAN cluster 200. In some examples, the master STA 115-i, acting as an anchor master device, may periodically beacon parameters regarding a default data path of the mesh network. The parameters may include default data path name, attribute ID, data path key, channel (e.g., 2.4 Ghz or 5 Ghz band) and control information to aid the requesting STA 115-h to establish communication with other devices 115 on the neighbor awareness network via an established default data path. In some examples, the default data path may traverse intermediate STA 115-b via communications links 225-a, 225-b and 225-c. Additionally or alternatively, the requesting STA 115-h may decide to establish a customized data path between the requesting device 115-h and the service device 115-k based in part on the system requirements of the requesting device 115-h. In some examples, the customized data path may instead traverse intermediate STA 115-l via communication links 225-d and 225-e. In some instances, the system requirement may comprise determining that an application for the requesting device 115-h requires enhanced encryption feature or a custom data path that are not met by the default data path. In such instances, the requesting device 115-h may transmit mesh attributes identifying the mesh where the application or services provided by the requesting STA 115-h may be available.

Alternatively, in order to establish communication between the requesting STA 115-h and the service STA 115-k utilizing the default data path, the requesting STA 115-h may transmit an indication to the service device 115-k identifying that the default data path will be utilized for subsequent data transmission between the requesting STA 115-h and the service STA 115-k. In some examples, the indication may be a subscription request. The master STA 115-i may also transmit advertisements identifying a data session window for stations 115 to transmit traffic over the NAN using the default data path. Thus, the requesting STA 115-h and the service STA 115-k, for example, may exchange data packets during the identified data session window. In some examples, the STA 115 may also transmit traffic announcements during a paging window when the stations 115 have data for transmission to the network. The traffic announcements may be transmitted during a paging window, the paging window selected based in part on number of stations 115 actively on the NAN 200. Additionally or alternatively, the service STA 115-k and the requesting STA 115-h may determine to utilize a default data path based on absence of an identifier in the subscription request. Thus, in some examples, the service STA 115-k may determine that the subscription request lacks an identifier specifying whether a default data path or a customized data path should be used for subsequent transmission. As a result, the serving STA 115-k may utilize a default data path in the absence of any preference identified by the request STA 115-h.

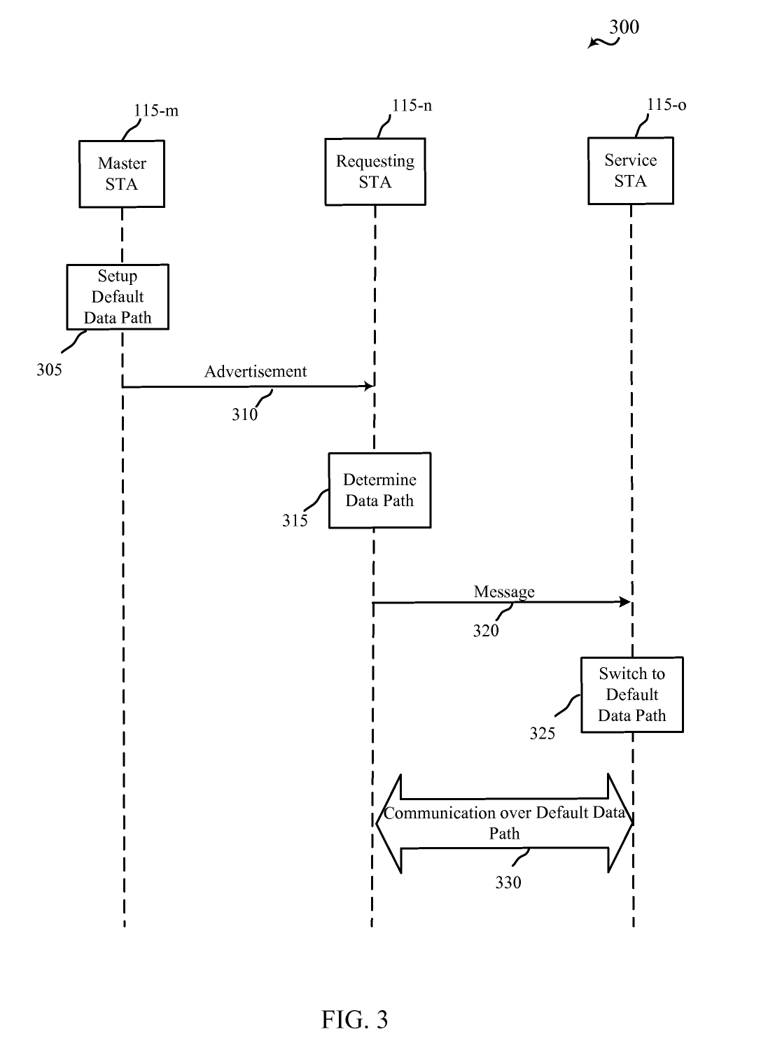

Now turning to FIG. 3, a message flow diagram illustrating a flow of communications between a master STA 115-m, requesting STA 115-n and service STA 115-o is disclosed. The master device 115-m may be one or more aspects of the master STA 115-i and/or wireless device 115 described with reference to FIGS. 1 and 2. Similarly, requesting STA 115-n and service STA 115-o may be an example of one or more STAs 115 described with references to FIGS. 1-2.

In some example of the present disclosure, the requesting STA 115-n and service station 115-o may provide authentication prior to establishing communication. For instance, the request STA 115-n and service STA 115-o may authenticate by establishing an association ID (AID), group key and pairwise security key exchange. In some examples of the present disclosure, the master device 115-f may setup default data path 305 by selecting a default data path channel (e.g., 2.4 Ghz or 5 Ghz band), default data path name, and/or data path control information. The master STA 115-m may also periodically advertise 310 default data path attributes one or more STAs on the network, including the requesting STA 115-n.

Upon receiving advertisement from an master STA 115-m, the requesting STA 115-n may determine whether to utilize a default data path or a customized data path 315 for establishing data transmission between the requesting STA 115-n and the service STA 115-o. In some examples, the requesting STA 115-n may base its determination in part on requirements of at least one or more applications running on the requesting STA 115-n. In other examples, the requesting STA 115-n may determine whether to utilize the default data path based on the level of security protocol required for at least one data packet configured for transmission. Thus, based on the determinations, the requesting STA 115-n may transmit a message 320 to the service STA 115-o. In some examples, the message 320 may be a subscription request and/or traffic announcement comprising an identifier that indicates a requesting STA 115-n preference for one of default data path or a customize data path. In other examples, the traffic announcements may be traffic indication map (TIM) message and/or service response filter (SRF) field in NAN Service Discovery message.

In response to receiving the message 325 at the service STA 115-o, the service STA 115-o may awake during a synchronized data transmission window and switch to the default data path to establish communication between the requesting STA 115-n and service STA 115-o. In some examples, the service STA 115-n may switch to the default data path based on an identifier included in the message 320 that indicates whether a default data path or a customized data path should be used for subsequent data transmission between the requesting STA 115-n and service STA 115-o. In some examples, switching to the default data path 325 may comprise switching to an identified channel for default data path broadcasted by the anchor master device 105-m. As a result, the requesting STA 115-n and service STA 115-o may establish communication 330 over the default data path. In some examples of the present disclosure, messages 310, 315 and 320 on the NAN may act as a heartbeat to keep the default data path alive. Once the either STA 115-n and 115-o cease to exchange data or messages on the default data path, the default data path may automatically disintegrate.

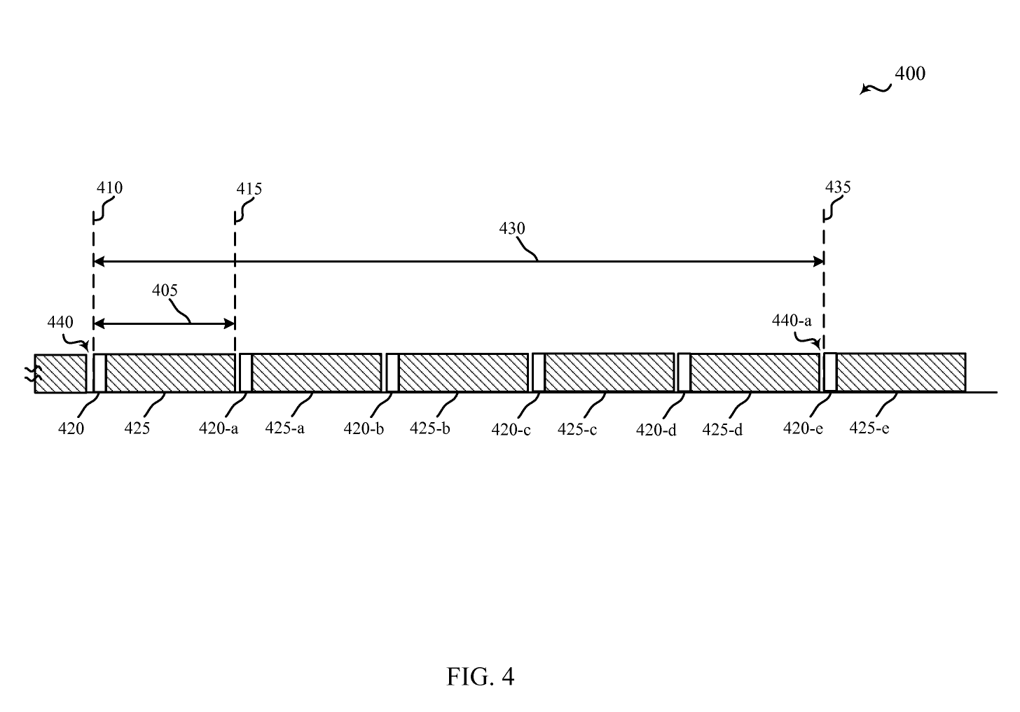

FIG. 4 shows a timing diagram 400 illustrating various timing aspects of the present disclosure, according to various embodiments. The timing diagram 400 may be implemented by one or more aspects of the wireless communication device 105 and/or the member STAs 115, described with reference to FIGS. 1, 2 and/or 3.

According to certain example, the NAN network 100 may be a synchronized network, i.e., all of the participating member device 115 may share a common timing reference to enable synchronized communications. Generally, the shared reference timing may include a data transmission session window 405 and a discovery window 440. The transmission window 405 may be defined as between times 410 and 415 and may include a paging window 420 at the beginning of the transmission window 405 as well as a transmission block 425. Generally, the participating member STAs 115 may all wake up during the paging window 420 to listen to the paging channel to determine whether there is any traffic being sent to the device 115. If there is traffic being sent, the STA 115 may remain awake during the transmission block 425 to exchange the traffic (i.e., control or data information). If there is no traffic being sent, the device 115 may transition back to a sleep state during the transmission block 425 to conserve power.

The discovery window 440 may occur during the time period between transmission windows 405. In some embodiments, the discovery window 440 may not occur before every transmission window 405 but may, instead, occur once per timing interval 430, e.g., between a predetermined number of paging windows 405. In the example shown in FIG. 4, the timing interval 430 may be defined as the time period between times 410 and 435.

Accordingly, the STA 115, once joined to the NAN network 100 and the overlay mesh network, may know when the transmission window 405 occurs, and the associated paging window 420. In some examples, the anchor master device of the NAN network may beacon synchronized timing information to all devices on the network. Additionally or alternatively, the anchor master device may broadcast and/or beacon information regarding default data path for the NAN network. The information may comprise the selected default channel (e.g., 2.4 Ghz or 5 Ghz), default attribute ID, data path key and data path control. In response, the member device 115 may communicate with other STAs 115 on the network utilizing the route request messages during the paging window 420 to ensure that each participating device 115 of the mesh network is awake and listening.

Referring now to FIG. 5A, a block diagram 500-a illustrates a requesting device 115-g in accordance with various embodiments. The requesting device 115-p may be an example of one or more aspects of the wireless communication device 115 described with reference to FIG. 1. The device 115-p may also be a processor. The device 115-p may include a receiver component 505, a communications management component 510, and a transmitter component 515. Each of these components may be in communication with each other.

The components of the device 115-p may, individually or collectively, be implemented with one or more application-specific integrated circuits (ASICs) adapted to perform some or all of the applicable functions in hardware. Alternatively, the functions may be performed by one or more other processing units (or cores), on one or more integrated circuits. In other embodiments, other types of integrated circuits may be used (e.g., Structured/Platform ASICs, Field Programmable Gate Arrays (FPGAs), and other Semi-Custom ICs), which may be programmed in any manner known in the art. The functions of each unit may also be implemented, in whole or in part, with instructions stored in a memory, formatted to be executed by one or more general or application-specific processors.

The transmitter component 515 may send communications via signals 508 from the device 115-p to other devices, such as the member device 115 of the NAN network 100 shown in FIG. 1. Sending such communications may include messages for executing the single authentication procedure. In some examples, sending communication may include transmitting service advertisements and/or traffic announcements. Traffic announcements may be an example of Traffic Indication Map (TIM) message and/or Service Response Filter (SRF) field in NAN Service Discovery messages. The communications may also include the route request messages utilized for discovering the other devices 115 of the existing mesh network. The transmitter component 515 may send communications by transmitting direct (addressed) communications to the member device 115 once the device 105 has discovered/identified a member device (e.g., the member device 115 of FIG. 1) utilizing established default data path and/or customized data path. The transmitter component 515 may also send communications by transmitting broadcast (non-addressed) communications to one or more of the other member devices 115 of the existing mesh network. Such broadcast transmissions may include the route request message that is broadcast to each member device 115 participating in the existing NAN network.

The receiver component 505 may receive communications via signals 502 from the member device 115. The receiver component 505 may receive messages for the authentication procedure via directed (addressed) messages transmitted from the member device 115. Additionally or alternatively, the receiver component 505 may receive service request and/or advertisement announcements identifying parameters of the default data path. The receiver component 505 may receive communications via signals 502 from other member devices 115 as part of the topology discovery/route determination process. The receiver component 505 may receive one or more route reply messages from the other member devices 115 in response to the route request message transmitted by the transmitter component 515. The communications management component 510 may manage such communications received by the device 115 via signal(s) 504 (e.g., control and/or data). Additionally, upon joining the network, the communications management component 510 may establish connections with one or more of the member devices 115 of the NAN network and may manage via signal(s) 506 (e.g., control and/or data) communications via such connections. Further details regarding the communications management component 510 will be described below.

FIG. 5B is a block diagram 500-b illustrating a device 115-q in accordance with various embodiments. The device 115-q may be an example of one or more aspects of the member devices 115, described with reference to FIGS. 1, 2 and/or 3. The device 115-q may also be a processor. The device 115-q may include a receiver component 505-a, a communications management component 510-a, and a transmitter component 515-a. Each of these components may be in communication with each other.

The components of the device 115-q may, individually or collectively, be implemented with one or more application-specific integrated circuits (ASICs) adapted to perform some or all of the applicable functions in hardware. Alternatively, the functions may be performed by one or more other processing units (or cores), on one or more integrated circuits. In other embodiments, other types of integrated circuits may be used (e.g., Structured/Platform ASICs, Field Programmable Gate Arrays (FPGAs), and other Semi-Custom ICs), which may be programmed in any manner known in the art. The functions of each unit may also be implemented, in whole or in part, with instructions stored in a memory, formatted to be executed by one or more general or application-specific processors.

The receiver component 505-a and the transmitter component 515-a may be examples of receiver component 505 and transmitter component 515, respectively, and may be configured to perform operations (e.g., via signals 512 and 522, respectively) as previously described with reference to FIG. 5A. The communications management component 510-a may be an example of communications management component 510 and may include an advertisement reception component 520, a route determination component 525, an encryption/decryption component 530, and a timing component 535.

The communications management component 510-a may be configured to perform the various functions described above with respect to FIG. 5A. In this example, the communications management component 510-a may manage (via internal signals 516) an authentication process to join a NAN network and establish communication with other devices via overlay mesh network providing and/or subscribing to one or more services available in the NAN network. The communications management component 510-a may further manage a route optimization process for discovering the topology of the existing default data path in the mesh network as well as determining a route to a provider member devices 115 providing such services, e.g., service device 115-c of the NAN network 200. The device 115-q or the communications management component 510-a may include a processor for performing such functionality.

The advertisement reception component 520 may be configured to execute various operations to participate in the default data path communication procedure as described herein. In some embodiments, the advertisement reception component 520 may receive advertisement beacons from the anchor master device identifying a default data path parameters for utilization by the device 115-q. In some examples, the default data path parameters may be repeated between consecutive discovery windows (DW) in order to keep the latency low by enabling several transmission opportunities. The default data path parameters may identify the default channel (e.g., 2.4 Ghz or 5 Ghz), default data path attribute ID, and control information.

The route determination component 525 may be configured to execute various operations to determine a route to a provider/service member device 115 of the existing NAN network 200. In some embodiments, the route determination component 525 may generate and provide one or more route request messages to the transmitter component 515-a via signals 518 to be transmitted via signals 522 to the other member devices 115. In other examples, the route determination component may analyze system requirements of the device 115-q to determine whether to utilize the default data path for data transmission or to establish a customized data path that matches device specific requirements. In some examples, the determination may be based on the applications executed on the device 115-h and transmission requirements of packets associated with device 115-q. For example, determining whether to utilize the default data path may be based on a further determination that an application executing on the device 115-q requires enhanced encryption feature or a custom data path that extends beyond the capabilities of the default data path.

In some embodiments, the route determination component 525 may generate an indication to be transmitted to the provider/service device identifying that the default data path may be utilized for the data transmission. Based on the determination of the route determination component 525, the device 115-q may transmit a traffic announcement and/or data packet to other member devices 115 in the network. Additionally or alternatively, the indication message may be broadcast to all member devices 115 participating in the NAN network that are proximate to the device 115-q. In some examples, the indication message may be a subscription request.

In some embodiments, the route determination component 525 may receive, via signals 514, one or more messages from the receiver component 505-a, that were received via signals 512 from the other member devices 115. The messages may be received in response to the route request messages. The messages may include information associated with the existing default data path of the NAN network. In some exemplary embodiments, the messages and/or announcements may include: (1) identification information associated with each of the member devices 115 that transmit a message; (2) channel quality information (e.g., signal strength, interference level, etc.) from each responding member device 115 indicative of the channel conditions between the responding member device 115 and the other member devices 115 it communicates with; (3) hop count information from a responding member device 115 to other member devices 115, including a provider member device 115 providing a desired service; (4) and other information associated with the existing mesh network 110 that may aid the joining device in discovering the mesh network 110.

The route determination component 525 may utilize the information contained in the received route reply messages to determine its neighbors (e.g., to discover the other participating devices 115 of the NAN network, services provided by the devices 115 and optimum routes to each of the devices). Based on this discovered mesh network topology, the route determination component 525 may determine a route to a provider member STA of the mesh network 110. For instance and referring to FIG. 2, the requesting STA may determine that the optimal route to the service STA may be through member devices 115, via communication links 225-c and 225-d. However, in certain situations, the most optimum route may not be required for simple applications and/or transfer of non-critical data. In such examples, the router determination 525 may elect to minimize overhead of setting up a customized mesh data path by selecting an established default data path. As a result, the device 115-q may not need to propagate device 115-q specific attributes, conduct channel interference mitigation, and/or establish a new data path. Thus, utilizing an existing default data path may act as an “on demand” data communication accessibility.

Additionally or alternatively, the communications management component 510-a may manage (via internal signals 516) further manage security for the device 115-q. The device 115-q or the communications management component 210-a may include a processor for performing such functionality.

According to various embodiments, the device 115-q may receive a common group key from the member device 115 during the signal authentication process. The common group key may be shared with each participating member device 115 of the NAN network. The encryption/decryption component 530 may be configured to perform security operations including encryption and decryption operations utilizing the common group key. With respect to the single authentication procedure, which should be secure, the encryption/decryption component 530 may, via signals 516 may encrypt messages generated by the device 115-q and may decrypt the messages received from the member device 115 and/or anchor master devices.

The encryption/decryption component 530 also may be configured to perform security operations for communications between the device 115-h and one or more of the member devices 115 once the device 115-q has joined the mesh network. Thus, the communications within the NAN network should be secure. With respect to the route determination process, the encryption/decryption component 530 may, via signals 516 exchanged with the route determination component 525, encrypt the route request messages and may decrypt the messages received from the member devices 115 using the common group key. Thus, only participating member devices 115 may have the common group key and, therefore, be able to receive, process, and respond to the route request messages. That is, as the participating member devices 115 share the common group key, this obviates the need for the device 115-q to form a mesh peering connection with all of the participating member devices 115 to participate in the route request/reply exchanges.

The timing component 535 may be configured to execute various operations regarding the timing of functions related to determining a route to a provider member device 115 of the NAN network 110 over default data path. The NAN network may be a synchronized network, i.e., all of the participating member device 115 may share a common timing reference to enable synchronized communications. As a result, the timing component 535 may be configured to maintain timing synchronization with the anchor master node and transmit/receive messages during synchronized data transmission session windows as described with reference to FIG. 4.

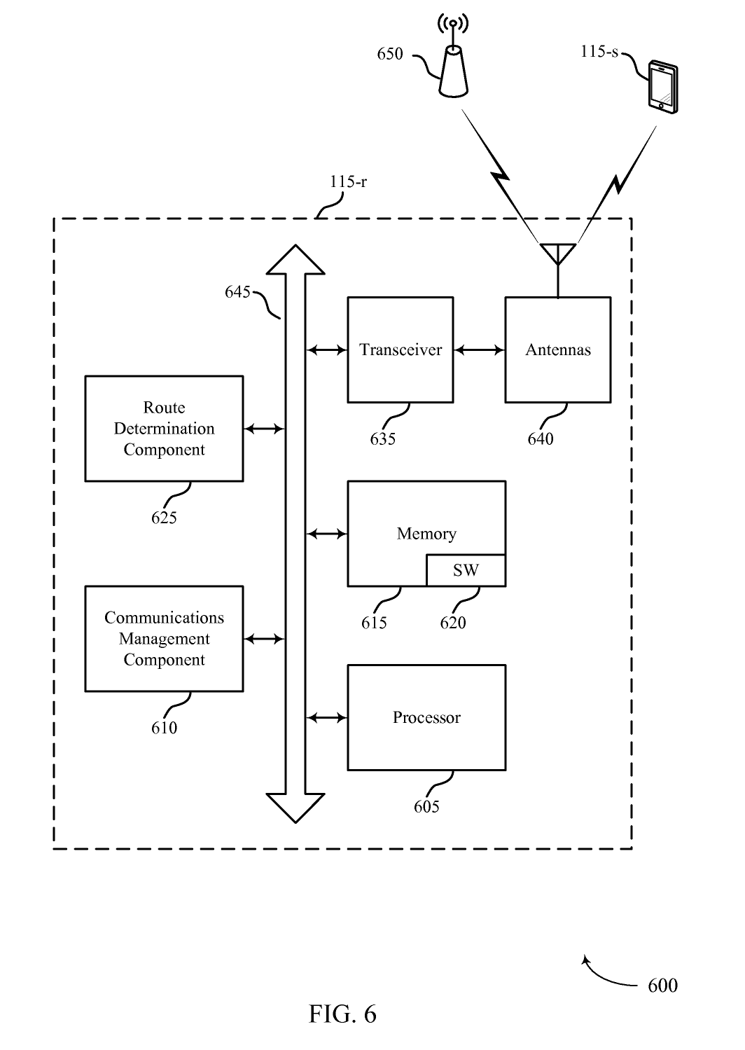

Turning to FIG. 6, a diagram 600 is shown that illustrates a communications device, or station, 115-r configured for NAN-related communication according to various embodiments. The STA 115-r may have various other configurations and may be included or be part of a personal computer (e.g., laptop computer, netbook computer, tablet computer, etc.), a cellular telephone, a PDA, a digital video recorder (DVR), an internet appliance, a gaming console, an e-readers, etc. The station 115-r may have an internal power supply (not shown), such as a small battery, to facilitate mobile operation. The station 115-r may be an example of the member devices 115 or communication devices 505 and may implement various operations of FIGS. 1-5.

The station 115-r may include a communications management component 610, which may be an example of a communications management component described with reference to FIG. 5. The station 115-r may also include a router determination component 625. The station 115-r may also include components for bi-directional voice and data communications including components for transmitting communications and components for receiving communications.

The route determination component 625 may be configured such that the station 115-i may determine whether to utilize the default data path for data transmissions or customized data path based in part on requirements of the station 115-r as described above with reference to FIG. 5B.

The station 115-r may also include a processor component 605, and memory 615 (including software (SW)) 620, a transceiver component 635, and one or more antenna(s) 640, which each may communicate, directly or indirectly, with each other (e.g., via one or more buses 645. The transceiver component 635 may be configured to communicate bi-directionally, via the antenna(s) 640 and/or one or more wired or wireless links, with one or more networks, as described above. For example, the transceiver component 635 may be configured to communicate bi-directionally with an external access point. The transceiver component 635 may include a modem configured to modulate the packets and provide the modulated packets to the antenna(s) 640 for transmission, and to demodulate packets received from the antenna(s) 740. While the station 115-r may include a single antenna 640, the station 115-k may also have multiple antennas 640 capable of concurrently transmitting and/or receiving multiple wireless transmissions. The transceiver component 635 may also be capable of concurrently communicating with one or more base stations 650.

The memory 615 may include random access memory (RAM) and read only memory (ROM). The memory 615 may store computer-readable, computer-executable software/firmware code 620 including instructions that are configured to, when executed, cause the processor component 605 to perform various functions described herein (e.g., call processing, database management, processing of carrier mode indicators, reporting channel state information (CSI), etc.). Alternatively, the software/firmware code 620 may not be directly executable by the processor component 605 but be configured to cause a computer (e.g., when compiled and executed) to perform functions described herein. The processor component 705 may include an intelligent hardware device, e.g., a central processing unit (CPU), a microcontroller, an ASIC, etc. may include RAM and ROM. The memory 615 may store computer-readable, computer-executable software/firmware code 620 including instructions that are configured to, when executed, cause the processor component 605 to perform various functions described herein (e.g., call processing, database management, processing of carrier mode indicators, reporting CSI, etc.). Alternatively, the software/firmware code 620 may not be directly executable by the processor component 605 but be configured to cause a computer (e.g., when compiled and executed) to perform functions described herein. The processor component 605 may include an intelligent hardware device, e.g., a CPU, a microcontroller, an ASIC, etc.

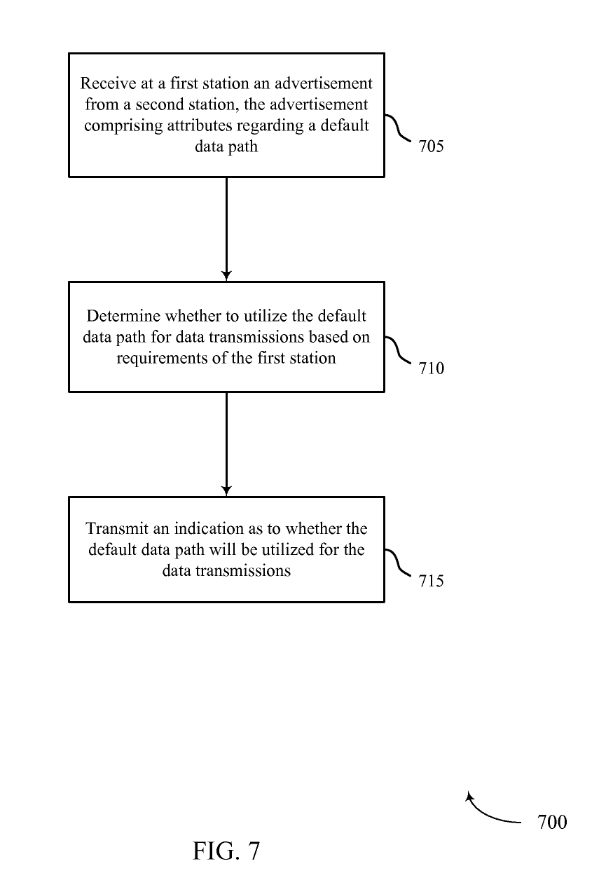

FIG. 7 shows a flowchart 700 illustrating a method performed by a station 115 for communications on a neighbor aware network via default data path on a mesh overlay. The functions of flowchart 700 may be implemented by a station 115 or one or more of its components as described with reference to FIGS. 1-6. In certain examples, one or more of the blocks of the flowchart 700 may be performed by the communications management component as described with reference to FIG. 5.

At block 705, the station 115 may receive at a first station an advertisement from a second station, the advertisement comprising attributes regarding a default data path as described above with reference to FIG. 5. In certain examples, the functions of block 705 may be performed by the advertisement reception component 520 as described above with reference to FIG. 5B.

At block 710, the station 115 may determine whether to utilize the default data path for data transmissions based at least in part on requirements of the first station as described above with reference to FIG. 5. In certain examples, the functions of block 710 may be performed by the route determination component 525 as described above with reference to FIG. 5B.

At block 715, the station 115 may transmit an indication as to whether the default data path will be utilized for the data transmissions as described above with reference to FIG. 5. In certain examples, the functions of block 715 may be performed by the transmitter component 515 as described above with reference to FIG. 5.

It should be noted that the method of flowchart 700 is just one implementation and that the operations of the method, and the steps may be rearranged or otherwise modified such that other implementations are possible.

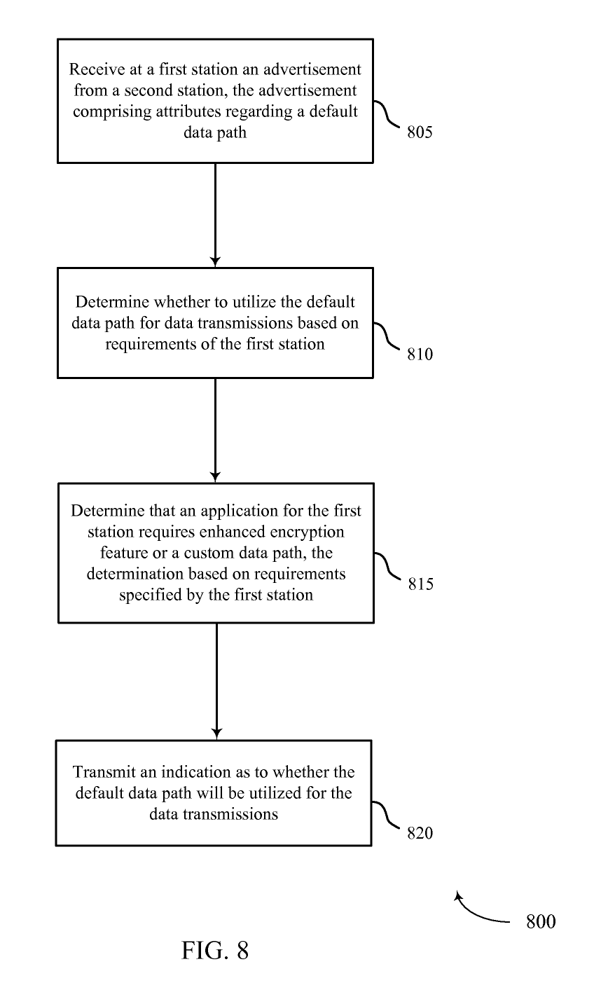

FIG. 8 shows a flowchart 800 illustrating a method performed by a station 115 for communications on a neighbor aware network via default data path on a mesh overlay. The functions of flowchart 800 may be implemented by a station 115 or one or more of its components as described with reference to FIGS. 1-6. In certain examples, one or more of the blocks of the flowchart 800 may be performed by the communications management component as described with reference to FIG. 5. The method described in flowchart 800 may also incorporate aspects of flowchart 700 of FIG. 7.

At block 805, the station 115 may receive at a first station an advertisement from a second station, the advertisement comprising attributes regarding a default data path as described above with reference to FIG. 5. In certain examples, the functions of block 805 may be performed by the advertisement reception component 520 as described above with reference to FIG. 5B.

At block 810, the station 115 may determine whether to utilize the default data path for data transmissions based at least in part on requirements of the first station as described above with reference to FIG. 5. In certain examples, the functions of block 810 may be performed by the route determination component 525 as described above with reference to FIG. 5B.

At block 815, the station 115 may determine that an application for the first station requires enhanced encryption feature or a custom data path, the determination based on requirements specified by the first station as described above with reference to FIG. 5. In certain examples, the functions of block 815 may be performed by the route determination component 525 as described above with reference to FIG. 5.

At block 820, the station 115 may transmit an indication as to whether the default data path will be utilized for the data transmissions as described above with reference to FIG. 5. In some examples, the indication may be a subscription requested. In certain examples, the functions of block 915 may be performed by the path indication component 515 as described above with reference to FIG. 5.

It should be noted that the method of flowchart 800 is just one implementation and that the operations of the method, and the steps may be rearranged or otherwise modified such that other implementations are possible.

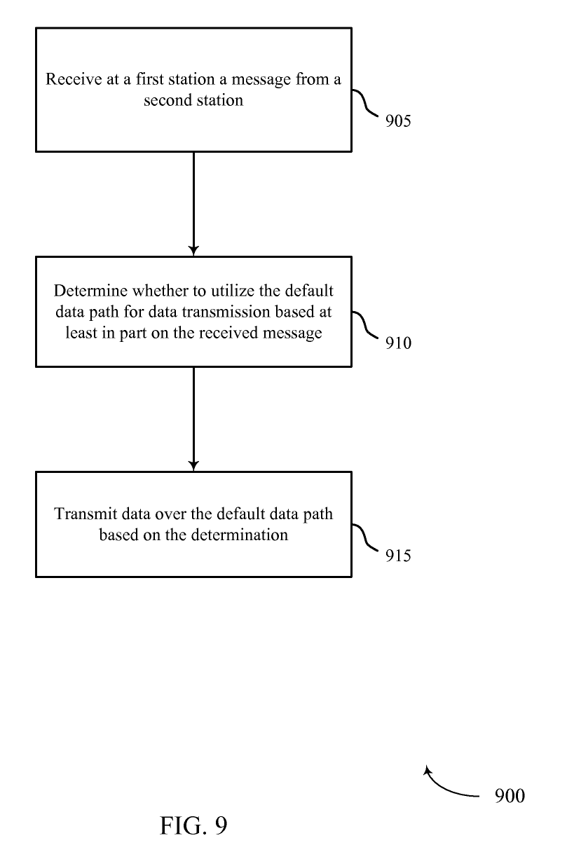

FIG. 9 shows a flowchart 900 illustrating a method performed by a STA 115 for communications on a neighbor awareness network via default data path on a mesh overlay. The functions of flowchart 900 may be implemented by a station 115 or one or more of its components as described with reference to FIGS. 1-6. In certain examples, one or more of the blocks of the flowchart 900 may be performed by the communications management component as described with reference to FIG. 5. The method described in flowchart 900 may also incorporate aspects of flowchart 700 and 800 of FIGS. 7 and 8.

At block 905, the station 115 may receive at a first station a message from a second station described above with reference to FIG. 5. In certain examples, the functions of block 805 may be performed by the receiver 505 as described above with reference to FIG. 5.

At block 910, the station 115 may determine whether to utilize the default data path for data transmissions based at least in part on the received message as described above with reference to FIG. 5. In some examples, the received message may include an identifier that indicates whether to utilize a default data path or a customized data path for subsequent data transmission. In certain examples, the functions of block 910 may be performed by the route determination component 525 as described above with reference to FIG. 5B.

At block 915, the station 115 may transmit data over the default data path based on the determination as described above with reference to FIG. 5. In certain examples, the functions of block 915 may be performed by the route determination component 515 as described above with reference to FIG. 5.

It should be noted that the method of flowchart 900 is just one implementation and that the operations of the method, and the steps may be rearranged or otherwise modified such that other implementations are possible.

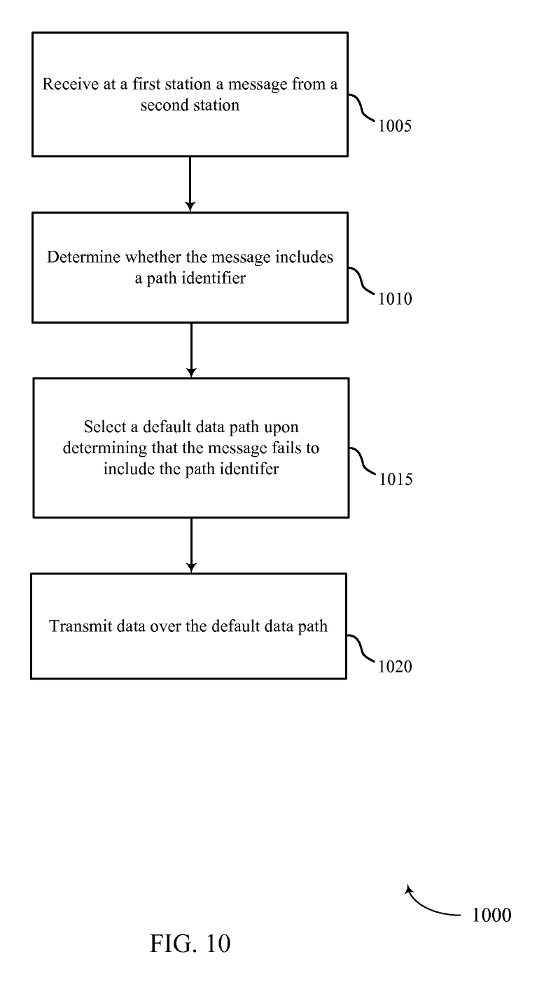

FIG. 10 shows a flowchart 1000 illustrating a method performed by a STA 115 for communications on a neighbor awareness network via default data path on a mesh overlay. The functions of flowchart 1000 may be implemented by a station 115 or one or more of its components as described with reference to FIGS. 1-6. In certain examples, one or more of the blocks of the flowchart 1000 may be performed by the communications management component as described with reference to FIG. 5. The method described in flowchart 1000 may also incorporate aspects of flowchart 700, 800 and 900 of FIGS. 7-9.

At block 1005, the station 115 may receive at a first station a message from a second station described above with reference to FIG. 5. In certain examples, the functions of block 905 may be performed by the receiver 505 as described above with reference to FIG. 5.

At block 1010, the station 115 may determine whether the message includes a path identifier that may identify whether to use a default data path or a customized data path as described above with reference to FIG. 5. In certain examples, the functions of block 910 may be performed by the route determination component 525 as described above with reference to FIG. 5B.

At block 1015, the station 115 may select a default data path upon determining that the message fails to include the path identifier as described above with reference to FIG. 5. In certain examples, the functions of block 1015 may be performed by the route determination component 515 as described above with reference to FIG. 5.

At block 1020, the station 115 may transmit data over the default data path based on the determination as described above with reference to FIG. 5. In certain examples, the functions of block 1020 may be performed by the route determination component 515 as described above with reference to FIG. 5.

It should be noted that the method of flowchart 900 is just one implementation and that the operations of the method, and the steps may be rearranged or otherwise modified such that other implementations are possible.

The detailed description set forth above in connection with the appended drawings describes exemplary embodiments and does not represent the only embodiments that may be implemented or that are within the scope of the claims. The term “exemplary” used throughout this description means “serving as an example, instance, or illustration,” and not “preferred” or “advantageous over other embodiments.” The detailed description includes specific details for the purpose of providing an understanding of the described techniques. These techniques, however, may be practiced without these specific details. In some instances, well-known structures and devices are shown in block diagram form in order to avoid obscuring the concepts of the described embodiments.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a digital signal processor (DSP), an ASIC, a FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates a disjunctive list such that, for example, a list of [at least one of A, B, or C] means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, electrically erasable programmable read only memory (EEPROM), compact disk (CD) ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not to be limited to the examples and designs described herein but is to be accorded the broadest scope consistent with the principles and novel features disclosed herein.

What is claimed is:

1. A method of wireless communication, comprising:
receiving at a first station a message from a second station;
determining whether to utilize a default data path for data transmissions based at least in part on the received message; and
transmitting data over the default data path based on the determining.

2. The method of claim 1, wherein determining whether to utilize the default data path comprises:
determining whether the message includes a path identifier; and
selecting the default data path upon determining that the message fails to include the path identifier.

3. The method of claim 1, wherein the message includes a path identifier, the path identifier indicating whether the default data path or a customized data path should be utilized for data transmission.

4. The method of claim 1, wherein determining whether to utilize the default data path further comprises:
determining that an application for the first station requires enhanced encryption feature or a custom data path, the determination based on requirements specified by the first station.

5. The method of claim 1, further comprising:
receiving an advertisement message from an anchor master device, the advertisement message included in a beacon comprising attributes associated with the default data path.

6. The method of claim 5, wherein the attributes include at least one of a selected channel and transmission schedule information of the default data path.

7. The method of claim 5, wherein the advertisement message is received during a periodic Neighbor Awareness network (NAN) discovery window.

8. The method of claim 7, wherein the advertisement message further identifies a data session window for the first station to transmit traffic over the default data path.

9. The method of claim 8, wherein transmitting data over the default data path includes transmitting during the identified data session window.

10. The method of claim 8, further comprising:
transmitting a traffic announcement during a paging window.

11. The method of claim 10, wherein the paging window duration is selected based in part on a number of devices participating on the default data path.

12. The method of claim 10, wherein the paging window occurs during a synchronized time interval and all stations on the default data path are in an active state during the paging window interval.

13. The method of claim 10, wherein the traffic announcement is transmitted using Traffic Indication Map (TIM) message.

14. The method of claim 10, wherein the traffic announcement is transmitted using Service Response Filter (SRF) field in NAN service discovery message.

15. The method of claim 1, further comprising:
synchronizing all stations on a Neighbor Awareness network (NAN) based in part on information received from beacons transmitted by the second station.

16. The method of claim 1, further comprising:
determining that the transmission of data over the default data path is completed; and
terminating the transmission over the default data path based on the determining.

17. The method of claim 1, further comprising:
determining that a service is unavailable; and
ceasing to transmit over the default data path based on the determining.

18. An apparatus for wireless communication, comprising:
a processor;
memory in electronic communication with the processor and instructions stored in the memory, wherein the instructions are executable by the processor to:
receive at a first station a message from a second station;
determine whether to utilize a default data path for data transmissions based at least in part on the received message; and
transmit data over the default data path based on the determining.

19. The apparatus of claim 18, wherein the instructions are executable by the processor to:
determine whether the message includes a path identifier; and
select the default data path upon determining that the message fails to include the path identifier.

20. The apparatus of claim 18, wherein the message includes a path identifier, the path identifier indicating whether the default data path or a customized data path should be utilized for data transmission.

21. The apparatus of claim 18, wherein the instructions are executable by the processor to:
determine that an application for the first station requires enhanced encryption feature or a custom data path, the determination based on requirements specified by the first station.

22. The apparatus of claim 18, wherein the instructions are executable by the processor to:
receive an advertisement message from a master device, the advertisement message comprising attributes associated with the default data path.

23. The apparatus of claim 22, wherein the attributes include at least one of a selected channel and transmission schedule information of the default data path.

24. The apparatus of claim 22, wherein the advertisement message is received during a periodic Neighbor Awareness network (NAN) discovery window.

25. The apparatus of claim 24, wherein the advertisement message further identifies a data session window for the first station to transmit traffic over the default data path.

26. The apparatus of claim 18, wherein the instructions are executable by the processor to:
synchronize all stations on a Neighbor Awareness network (NAN) based in part on information received from beacons transmitted by the second station.

27. A non-transitory computer-readable medium storing code for wireless communication, the code comprising instructions executable by a processor to:
receive at a first station a message from a second station;
determine whether to utilize the default data path for data transmissions based at least in part on the received message; and
transmit data over the default data path based on the determining.

28. The computer-readable medium of claim 27, wherein the instructions are executable by the processor to:
determine that an application for the first station requires enhanced encryption feature or a custom data path, the determination based on requirements specified by the first station.

29. An apparatus for wireless communication, comprising:
means for receiving at a first station a message from a second station;
means for determining whether to utilize the default data path for data transmissions based at least in part on the received message; and
means for transmitting data over the default data path based on the determining.

30. The apparatus of claim 29, wherein means for determining whether to utilize the default data path comprises:
means for determining whether the message includes a path identifier; and
means for selecting the default data path upon determining that the message fails to include the path identifier.
